(19) United States
(12) Patent Application Publication
(10) Pub. No.: US 2026/0185917 A1
(43) Pub. Date: Jul. 2, 2026

(54) PHOTODETECTOR

(71) Applicant: DONGWOO FINE-CHEM CO., LTD., Jeollabuk-do (KR)

(72) Inventors: GI HWAN AHN, Jeollabuk-do (KR); SUNG HO BAEK, Jeollabuk-do (KR); SEUNG PIL HAN, Jeollabuk-do (KR); GI YONG NAM, Jeollabuk-do (KR); MIN JU LEE, Jeollabuk-do (KR); SU YOUNG CHOI, Jeollabuk-do (KR); MIN GI HWANG, Jeollabuk-do (KR)

(21) Appl. No.: 19/318,659

(22) Filed: Sep. 4, 2025

(30) Foreign Application Priority Data
Dec. 26, 2024 (KR) 20-2024-0002323

(51) Int. Cl. G01N 15/075; G01N 15/00; G01N 21/05

(52) U.S. Cl. CPC G01N 15/075; G01N 21/05; G01N 2015/0038; G01N 2201/0697

(57) ABSTRACT

A photodetector includes a flow cell configured to allow a liquid sample containing nanoparticles to flow, a laser generating unit irradiating a pulsed laser beam on the flow cell and generating a plasma, a flow control unit controlling a flow of the liquid sample inside the flow cell, an integrating sphere reflecting multiply an optical signal from the plasma, and a spectrometer measuring the optical signal reflected from the integrating sphere.

### CROSS-REFERENCE TO RELATED APPLICATION AND CLAIM OF PRIORITY

This application claims the benefit under 35 USC § 119 of Korean Patent Application No. 20-2024-0002323 filed on Dec. 26, 2024 in the Korean Intellectual Property Office, the entire disclosure of which is incorporated herein by reference for all purposes.

### BACKGROUND

1. Technical Field

The present invention relates to a photodetector.

### 2. Background Art

Various organic or inorganic chemicals used in the manufacturing process of products requiring high precision, such as displays and semiconductors, are demanding higher purity chemicals than currently available to prevent a decrease in manufacturing yield. In addition, high-level analysis technologies are being developed and newly applied to confirm the quality of high-purity chemicals.

The importance of particle analysis is increasing. Nano-scale small particles can reduce the yield of semiconductor manufacturing processes and affect the high integration of semiconductor manufacturing processes. Accordingly, the development of stable analysis methods for quality control is required, and the scalability of technology must be guaranteed so that the causes of defects that may occur during the process can be analyzed.

Generally, a solution is a state in which a substance is evenly dispersed in a liquid in the form of molecules or ions. In such a solution, fine particles larger than ordinary molecules or ions and having a diameter of 1 nm to 1000 nm are dispersed without agglomeration or precipitation, and this state is called a colloidal state. Things in this colloidal state are called colloids.

The study of micro-colloids present in solutions is focused on obtaining information on the physicochemical properties of the substance to be analyzed or on improving the detection power of a separation analyzer. The analysis of colloidal particles performed until recently has been limited in that it has been performed on colloidal particles exceeding 100 nm. Accordingly, the development of technology is required in that a high-concentration sample is required for accurate analysis of colloidal particles less than 100 nm.

### SUMMARY

An aspect of the present invention provides a photodetector that improve measurement reliability for measuring nanoparticles.

A photodetector according to an exemplary embodiment of the present invention, comprises a flow cell configured to allow a liquid sample containing nanoparticles to flow; a laser generating unit irradiating a pulsed laser beam on the flow cell and generating a plasma; a flow control unit controlling a flow of the liquid sample inside the flow cell; an integrating sphere reflecting multiply an optical signal from the plasma; and a spectrometer measuring the optical signal reflected from the integrating sphere.

In an exemplary embodiment, the spectrometer may analyze information on the nanoparticles through a spectrum of the optical signal.

In an exemplary embodiment, an inner surface of the integrating sphere may be coated so that the inner surface of the integrating sphere multiply reflects the optical signal.

In an exemplary embodiment, the flow cell may be disposed inside the integrating sphere.

In an exemplary embodiment, the photodetector may further comprise a flow cell holder placed in the integrating sphere, the flow cell holder fixing the flow cell.

In an exemplary embodiment, the flow cell may be detachably mounted to the flow cell holder.

In an exemplary embodiment, a surface of the flow cell holder may be configured to reflect the optical signal.

In an exemplary embodiment, an inner surface of the integrating sphere and the surface of the flow cell holder may be configured to reflect a light of wavelength between 180 to 2500 nm.

In an exemplary embodiment, the inner surface of the integrating sphere and the surface of the flow cell holder may be configured to reflect a light of wavelength between 200 to 1100 nm.

In an exemplary embodiment, a flow path may be formed inside the integrating sphere, the liquid sample may flow in the flow path.

In an exemplary embodiment, the photodetector may further comprise a notch filter disposed on a path along which the optical signal is incident on the spectrometer.

In an exemplary embodiment, the photodetector may further comprise an optical condenser collecting the optical signal reflected from an inner surface of the integrating sphere.

In an exemplary embodiment, the photodetector may further comprise an optical fiber connecting the integrating sphere and the spectrometer, the optical fiber may transmit the optical signal multiply reflected from the integrating sphere to the spectrometer.

In an exemplary embodiment, a first opening may be formed on a side of the integrating sphere, a second opening may be formed on another side of the integrating sphere, the pulsed laser beam may be configured to enter an interior of the integrating sphere through the first opening, and at least a portion of the pulsed laser beam may be configured to exit the integrating sphere through the second opening.

In an exemplary embodiment, the photodetector may further comprise a camera detecting an image of the optical signal generated from the plasma, the camera may be displaced at a side of the integrating sphere.

In an exemplary embodiment, the spectrometer and the camera may penetrate a surface of the integrating sphere, so that at least a portion of the spectrometer and at least a portion of the camera are positioned inside the integrating sphere.

In an exemplary embodiment, the photodetector may further comprise a data storage storing a signal detected through the spectrometer.

In an exemplary embodiment, the laser generating unit may include an attenuator adjusting an intensity of the pulsed laser beam.

The photodetector according to an exemplary embodiment of the present invention can analyze the type of nanoparticles in a liquid sample by using a spectrometer.

A photodetector according to an exemplary embodiment of the present invention can amplify an optical signal emitted from an induction plasma and obtain a uniformed signal through multiple reflections of light on the inner surface of the integrating sphere by arranging a flow cell inside the integrating sphere. Accordingly, more precise and accurate analysis of nanoparticle information can be made possible.

### BRIEF DESCRIPTION OF THE DRAWINGS

The accompanying drawings, which are included to provide a further understanding of the disclosure and are incorporated in and constitute a part of the disclosure, illustrate embodiments of the disclosure and together with the description serve to explain the principle of the disclosure.

FIG. 1 is a schematic diagram of a fluidic nanoparticle measurement device including a photodetector according to an embodiment of the present invention.

FIG. 2 is a schematic diagram of a fluidic nanoparticle measurement device according to an embodiment of the present invention.

FIG. 3 is a drawing schematically illustrating components related to a photodetector according to an embodiment of the present invention.

FIG. 4 is a drawing schematically illustrating arrangement of components of the photodetector according to an embodiment of the present invention.

### DETAILED DESCRIPTION OF THE EMBODIMENTS

The embodiments of the present invention are provided to more completely explain the present invention to those skilled in the art, and the following embodiments may be modified in various different forms, and the scope of the present invention is not limited to the following embodiments.

For convenience of explanation, some embodiments of the present invention are described below with reference to exemplary drawings. When designating reference numerals for components in each drawing, identical components are indicated with the same numerals as much as possible even if they are shown in different drawings.

The terms or words used in this specification and claims should not be limited to their usual or dictionary meanings, and should be interpreted as having meanings and concepts that conform to the technical idea of the present invention, based on the principle that the inventor can appropriately define the concept of the term in order to explain his or her own invention in the best way.

The terms used herein are used to describe particular embodiments and are not intended to limit the invention. As used herein, the singular form may include the plural form unless the context clearly dictates otherwise.

Also, when used to describe and assert the present disclosure, the words “comprise,” “include,” “consist of,” and “have” should be construed in a non-exclusive manner, and unless otherwise specifically stated, should be construed to imply that the component may be present, and thus not to the exclusion of other components, but rather to the inclusion of other components.

In addition, when describing components of an embodiment of the present invention, terms such as first, second, A, B, (a), (b), etc. may be used. These terms are only intended to distinguish the components from other components, and the nature, order, or sequence of the components are not limited by the terms.

When a component is described as being ‘connected’ or ‘coupled’ to another component, it should be understood that the component may be directly connected or coupled to the other component, but that another component may also be ‘connected’or ‘coupled’between the component and the other component.

Terms related to space, such as “beneath,” “below,” “lower,” “above,” and “upper,” may be used to facilitate understanding of one element or feature and another element or feature depicted in the drawings. These terms related to space are provided to facilitate understanding of the present invention in various process states or usage states, and are not intended to limit the present invention. For example, if an element or feature in a drawing is flipped, an element or feature described as “beneath” or “below” becomes “above” or “above.” Accordingly, “beneath” is a concept that includes “upper” or “below.”

The embodiments described in this specification and the configurations illustrated in the drawings are only the most preferred embodiments of the present invention and do not represent all of the technical ideas of the present invention, so it should be understood that there may be various equivalents and modified examples that can replace them at the time of this application. In addition, detailed descriptions of well-known functions and configurations that may unnecessarily obscure the gist of the present invention are omitted.

The present invention may relate to a photodetector 110 which can be applied to a fluidic nanoparticle measurement device 1.

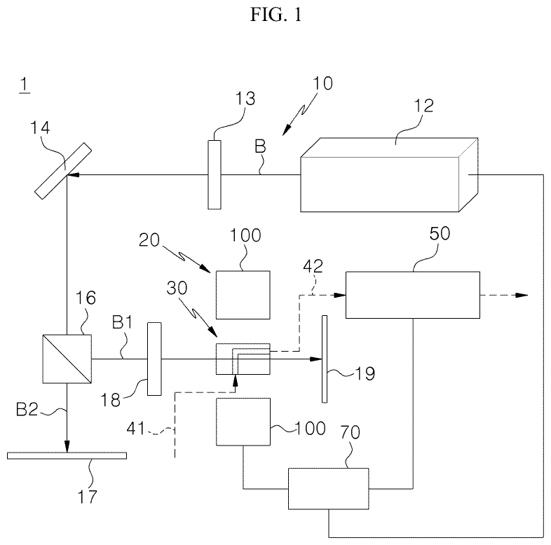

The fluidic nanoparticle measurement device 1 can use a laser-induced breakdown detection (LIBD) method. The LIBD method is a technology that uses the principle of laser-induced plasma generated inside the focal area of the lens 18 (see FIG. 1) when a pulsed laser beam with a pulse width of several nanoseconds is incident on the lens 18 (see FIG. 1). Specifically, when the pulsed laser beam is irradiated on a nanoparticle, the energy level of the nanoparticle becomes excited. Thereafter, the nanoparticle in the excited state emits energy to become into a stable state, i.e., the ground state. The released energy causes plasma or shock waves to be generated in the nanoparticle.

The phenomenon that generates plasma or shock waves is called the Breakdown phenomenon. Energy is required to generate plasma, and the minimum energy required is called the threshold energy. The ionization energy required for each substance is different, and the threshold energy depends on the phase of the substance. The threshold energy is highest when the substance is in a gaseous state, and the threshold energy decreases sequentially when the substance is in a liquid state and a solid state.

The energy of the laser beam required to generate the laser-induced plasma increases sequentially when the nanoparticle is in the solid, liquid, and gas states. Accordingly, when appropriate laser beam energy is used, only the solid particles in the aqueous solution can break down to be in the laser-induced plasma state.

The breakdown probability of particles is dependent on the concentration of the particles, and the threshold energy of the laser beam required for the breakdown is dependent on the size of the particles. These properties can be used for analyzing the concentration or size of the nanoparticles. In addition, the elemental components of the nanoparticles can be analyzed by using the spectrum of the induced plasma. Accordingly, it is possible to simultaneously identify the physical properties and chemical components of the particles.

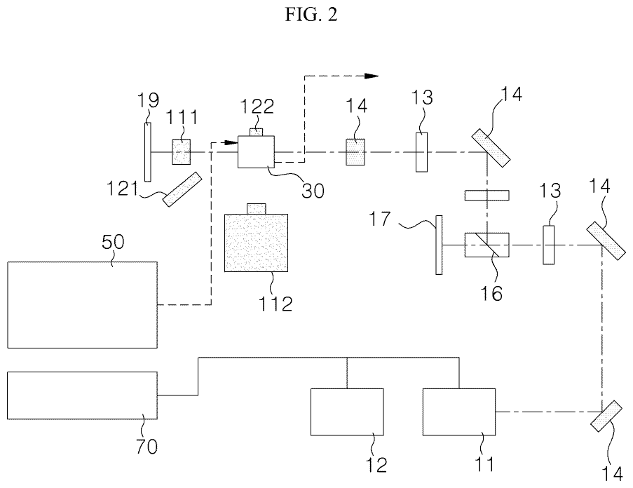

FIG. 1 is a schematic diagram of a fluidic nanoparticle measurement device including a photodetector according to an embodiment of the present invention. FIG. 2 is a schematic diagram of a fluidic nanoparticle measurement device according to an embodiment of the present invention.

Referring to FIGS. 1 and 2, a fluidic nanoparticle measurement device 1 may include a laser generating unit 10 and a flow device 20.

The laser generating unit 10 may include at least one of a laser generating device 12, an optical aperture 13, a mirror 14, a beam splitter 16, a first energy detector 17, a lens 18, or a second energy detector 19.

The laser generating device 12 can generate a pulsed laser beam B. The wavelength of the pulsed laser beam B is not limited to a specific wavelength range. The laser generating device 12 may generate the pulsed laser beam B by using Q-switching. The laser generating device 12 may generate the pulsed laser beam B repeatedly with a cycle. For example, the laser generating device 12 may generate the pulsed laser beam B with a first cycle by on/off. The laser generating device 12 includes the Nd: YAG laser generating a laser beam with 532 nm wavelength. However, it is not limited thereto, and the type and energy of the pulsed laser beam B generated from the laser generating device 12 can be applied in various ways.

An optical aperture 13, may be positioned on a side of the laser generating device 12, and can adjust the diameter of the pulsed laser beam B emitted from the laser generating device 12 and then incident on the optical aperture 13.

The mirror 14 may be arranged on the path of the pulsed laser beam B and can change the path of the pulsed laser beam B. In addition, as the number of mirrors 14 disposed on the path of the pulsed laser beam B increases, the pulsed laser beam B with the desired wavelength can be allowed to reach the flow cell 30.

The beam splitter 16 can control the intensity of the pulsed laser beam B by changing the path of the pulsed laser beam B or by splitting the pulsed laser beam B. The beam splitter 16 can control the path of the pulsed laser beam B so that at least a portion of the pulsed laser beam B incident on the beam splitter 16, that is, the first pulsed laser beam B1, is directed to the flow cell 30.

In addition, the second pulsed laser beam B2 branched from the first pulsed laser beam B1 at the beam splitter 16 may be measured by the first energy detector 17. Therefore, the energy of the first pulsed laser beam B1 irradiated to the flow cell 30 can be monitored.

The first energy detector 17 can detect the second pulsed laser beam B2. The first energy detector 17 can detect the second pulsed laser beam B2 bifurcated from the pulsed laser beam B with a certain ratio, so that the energy of the first pulsed laser beam B1 incident on the flow cell 30 can be deduced.

The lens 18 can be arranged or adjusted so that the focal point of the first pulsed laser beam B1 incident on the flow cell 30 is disposed on the liquid sample inside the flow cell 30. The lens 18 may adjust the irradiation area of the flow cell 30 on which the first pulsed laser beam B1 is irradiated. By adjusting the irradiation area of the flow cell 30, the lens 18 can improve the detectability of nanoparticles. The focal length of the lens 18 can be adjusted based on the Gaussian distribution of the plasma of the nanoparticles which is induced by the first pulsed laser beam B1. The focal length of the lens 18 may be set to 10 to 40 nm. However, the focal length of the lens 18 is not limited thereto.

The point where the induced plasma is generated may be the point where the first pulsed laser beam B1 and the nanoparticles are met. For example, the point where the induced plasma is generated may be the same as or adjacent to the focal point of the first pulsed laser beam B1 propagating in the flow cell 30. For example, the point where the induced plasma is generated may be dependent on the refractive index of the liquid sample contained in the flow cell 30. Accordingly, it may be necessary to adjust the focal length of the first pulsed laser beam B1 in order to measure various liquid samples.

The distance between the lens 18 and the flow cell 30 can be adjusted based on the type of the liquid sample. The distance between the lens 18 and the flow cell 30 can be adjusted by the control unit 70.

The second energy detector 19 can detect the first pulse laser beam B1 that has passed through the flow device 20. In an exemplary embodiment, the control unit 70 can compare the energy of the second pulse laser beam B2 detected by the first energy detector 17 with the energy of the first pulse laser beam B1 detected by the second energy detector 19. Through this, the control unit 70 can analyze the energy involved in the generation of plasma.

Meanwhile, the laser generating unit 10 may further include an attenuator 11 that adjusts the intensity of the pulsed laser beam B. For example, the attenuator 11 can decrease the intensity of the pulsed laser beam B which is incident on the attenuator 11. For example, the intensity of the pulsed laser beam B which is incident on the attenuator 11 may be greater than the intensity of the pulsed laser beam B which has passed through the attenuator 11.

The fluid device 20 may be configured to flow a liquid sample. The fluid device 20 may include a flow cell 30.

The flow cell 30 may be configured to allow a liquid sample to flow inside the flow cell 30. The flow cell 30 may include a cell inlet through which the liquid sample is introduced to the flow cell 30. The cell inlet of the flow cell 30 may be a portion through which the liquid sample is introduced into the flow cell 30.

The flow cell 30 may include a cell outlet through which the liquid sample flows out. The cell outlet of the flow cell 30 may be a portion through which the liquid sample flows out of the flow cell 30.

The flow cell 30 may be made of materials including quartz. However, it is not limited to quartz, and a polymer material such as acrylic can be used for making the flow cell 30 depending on the type of liquid sample.

The shape of the flow cell 30 is explained assuming that the outer shape of the flow cell 30 is a rectangular cell, but the shape of the flow cell 30 is not limited [symbol] rectangular cell. However, for example, when the flow cell 30 is configured as a rectangular cell, the detector may be positioned in a direction perpendicular to the outer surface of the rectangular cell, or in a direction inclined at a certain angle with respect to the outer surface of the rectangular cell.

However, the shape of the flow cell 30 and the arrangement of the detector according to the shape of the flow cell 30 are not limited thereto. The liquid sample may flow inside the flow cell 30, and at least a part of the flow cell 30 may be made of a light-transmitting material so that the first pulsed laser beam B1 can be irradiated to the liquid sample located inside the flow cell 30.

The flow cell 30 may include a flow portion in which the liquid sample flows inside the flow cell 30. The flow portion of the flow cell 30 may be formed in a shape of ‘┐’. The flow portion of the flow cell 30 may connect an inlet portion 41 and an outlet portion 42.

However, the shape of the flow portion of the flow cell 30 is not limited to the ‘┐’ shape. For example, the flow portion of the flow cell 30 may be configured to connect the inlet portion 41 and the outlet portion 42 and to allow the liquid sample to flow.

The size and shape of the inner diameter of the flow portion of the flow cell 30 may be various. For example, the inner diameter of the flow portion of the flow cell 30 can be the same as or less 10 mm.

For example, the flow portion of the flow cell 30 may have a rectangular cross-section or a circular cross-section.

In an exemplary embodiment, when the flow portion of the flow cell 30 is formed with a circular cross-section, the distance from the flow portion of the flow cell 30 to the detector according to the detector arrangement direction can be configured to be the same. Accordingly, the constraints on the detector arrangement can be reduced. In addition, the reliability of the detection result can be improved accordingly.

In an exemplary embodiment, when the flow portion of the flow cell 30 is formed with a square cross-section, the first pulsed laser beam B1 can be irradiated or the plasma can be measured in a direction perpendicular to the cross-section of the flow cell 30, so that distortion such as refraction of the signal can be reduced. Through this configuration, more accurate detection results can be obtained. In addition, when the flow portion of the flow cell 30 is formed with a square cross-section, the flow path can be formed larger for the same width. Accordingly, the flow portion of the flow cell 30 can derive smooth flow of the liquid sample.

However, the shape of the flow portion of the flow cell 30 described above is exemplary, and the shape of the flow portion of the flow cell 30 is not limited to the above-described one. For example, at least a part of the flow portion of the flow cell 30 may be formed as a curved surface, and the remainder may be formed as a flat surface.

For example, the cross-section of the flow portion of the flow cell 30 can be formed as a shape combining a curved surface and a polygon. If a part of the flow portion of the flow cell 30 is formed as the curved surface, the detection intensity can be maximized. In addition, bubble generated in the liquid sample according to the flow rate can be minimized.

The size of the inner diameter of the flow portion of the flow cell 30 can be formed to be constant throughout the entire section. Alternatively, the size of the inner diameter of the flow portion of the flow cell 30 can be configured to vary along the flow direction of the liquid sample. Specifically, the flow portion of the flow cell 30 can be divided into a plurality of sections, and the size of the inner diameter of the flow portion of the flow cell 30 can be configured to vary for each section. Among the flow sections of the flow portion, the main flow section can be configured to have a different size and shape of the inner diameter from that of other flow sections.

The flow portion of the flow cell 30 can form a path through which the liquid sample flows. The flow portion of the flow cell 30 can be connected to the cell inlet or the cell outlet.

The flow portion of the flow cell 30 may include the main flow section through which the first pulsed laser beam B1 is transmitted. The main flow section may form a flow space in which a liquid sample flows. The main flow section may be configured so that the first pulsed laser beam B1 is irradiated into the flow space. The flow space of the main flow section may form a path in which the liquid sample flows in one direction.

The main flow section through which the first pulsed laser beam B1 is transmitted may be a part of the flow portion or may be the entire flow portion. For example, the part before the flow portion is bent may be the main flow section. However, the present invention is not limited thereto, and the part after the flow portion is bent may be the main flow section, or the entire flow portion may be defined as the main flow section. The position of the main flow section in the flow portion is not limited.

The first pulsed laser beam B1 can be irradiated to the flow path of the liquid sample passing through the main flow section. Specifically, the first pulsed laser beam B1 can be irradiated to the center of the flow path of the liquid sample passing through the main flow section. However, the irradiation position of the first pulsed laser beam B1 with respect to the main flow section is not limited to the flow path or the center of the flow path.

The flow direction of the liquid sample passing through the main flow section and the irradiation direction of the first pulsed laser beam B1 may be arranged to be vertical to each other. That is, the flow path of the liquid sample formed inside the main flow section and the first pulsed laser beam B1 incident on the main flow section may be configured to be perpendicular to each other. However, the present invention is not limited thereto, and the flow direction of the liquid sample and the irradiation direction of the first pulsed laser beam B1 may be adjusted to form a horizontal or vertical or non-horizontal angle. The angle formed by the flow direction and the irradiation direction of the first pulsed laser beam B1 may be applied differently depending on the type of detector.

The flow cell 30 may be configured such that at least a portion of the flow cell 30 including the main flow section includes a light-transmitting material for irradiation of the first pulsed laser beam B1. Through this, the first pulsed laser beam B1 may pass through the flow cell 30 and be irradiated onto the liquid sample passing through the main flow section.

The flow device 20 may include an inlet portion 41. The flow device 20 may include an outlet portion 42.

The liquid sample can be introduced into the flow cell 30 through the inlet portion 41. The liquid sample contained in the flow cell 30 can be discharged to the outside of the flow device 20 through the outlet portion 42.

A storage tank can store the liquid sample. The inlet portion 41 and the outlet portion 42 can be connected to one storage tank. Accordingly, the liquid sample discharged from the storage tank to the inlet portion 41 can flow into the storage tank through the outlet portion 42. However, the present invention is not limited thereto, and each of the inlet portion 41 and the outlet portion 42 can be connected to an independent storage tank.

The flow device 20 may include a flow control unit 50.

The flow control unit 50 may be positioned on the flow path of the liquid sample. The flow control unit 50 may be configured to control the flow rate or the flow volume of the liquid sample passing through the flow cell 30. The control unit 70 may control the flow rate or the flow volume of the liquid sample passing through the flow cell 30 by controlling the flow control unit 50.

In an exemplary embodiment, the flow control unit 50 may be located on a path between the flow cell 30 and the outlet portion 42 as illustrated in FIG. 1. The path between the flow cell 30 and the outlet portion 42 may be downstream of the flow direction of the liquid sample. Accordingly, contamination of the liquid sample to be measured may be minimized. However, the arrangement of the flow control unit 50 is not limited to between the flow cell 30 and the outlet portion 42.

For example, the flow control unit 50 may be located on the path between the flow cell 30 and the inlet portion 41. The flow control unit 50 is configured to control the flow rate of the liquid sample flowing through the flow cell 30, and the flow control unit 50 may be placed at a location where contamination of the liquid sample does not occur.

In an exemplary embodiment, the flow control unit 50 can control the liquid sample to flow in the main flow section. In an exemplary embodiment, the flow control unit 50 can control the flow rate so that a certain amount of liquid sample can be sequentially positioned in the main flow section in a stationary state. That is, the flow control unit 50 can control the liquid sample to flow repeatedly with a certain period of pulse.

The flow control unit 50 can operate so that the flow state and the flow-stop state of the liquid sample alternate at a regular cycle. The flow state may mean a state in which the liquid sample flows in the flow portion of the flow cell 30. The flow-stop state may mean a state in which the liquid sample does not flow in the flow portion of the flow cell 30.

The flow control unit 50 can control the flow of the liquid sample so that the flow state and the flow-stop state are alternate in a pulse form. When the flow control unit 50 operates so that the liquid sample flows through the fluid unit at a constant linear velocity, the liquid sample can be in a flow state. The linear velocity may be constant, but is not limited thereto, and the size and change of the linear velocity may vary. When the flow control unit 50 suppresses the flow of the liquid sample, the liquid sample may be in the flow-stop state. The flow control unit 50 may operate to repeat the flow state and the flow-stop state through a signal transmitted by the control unit 70, or may operate to repeat the flow state and the flow-stop state mechanically. There may be various methods for implementing the operation of the flow control unit 50. For example, if the flow of the liquid sample is controlled by the flow control unit 50, this may be a method for implementing the operation of the flow control unit 50.

The irradiation of the first pulsed laser beam B1 by the laser generating device 12 and the flow operation of the liquid sample by the flow control unit 50 may be configured to correspond to each other. The period of the pulsed laser beam B and the period of the flow control unit 50 may be configured to be the same.

In an exemplary embodiment, the flow control unit 50 can control the flow of the liquid sample so that the flow rate of the liquid sample passing through the flow cell 30 corresponds to the period of the pulsed laser beam B. The operation of the flow control unit 50 into a flow-stop state and the irradiation of the first pulsed laser beam B1 by the laser generating device 12 can be performed repeatedly with the same time point, or can be performed repeatedly with a time point delayed by a certain period of time.

For example, when the flow control unit 50 is operated in a flow-stop state, the flow control unit 50 can stop the flow of the liquid sample in the main flow section. At this time, the laser generation unit 10 can generate an induction plasma for nanoparticles in the liquid sample by irradiating the first pulsed laser beam B1 to the main flow section of the flow cell 30.

When the flow control unit 50 operates in the flow state, the flow control unit 50 can flow the liquid sample in which the induced plasma is generated to the downstream, and can cause the liquid sample of the upstream which is not exposed to the first pulsed laser beam B1 to flow into the main flow section. At this time, the laser generation unit 10 can be controlled so that the first pulsed laser beam B1 is not irradiated to the main flow section.

When the flow control unit 50 operates again in a flow-stop state, the liquid sample that is not exposed to the first pulsed laser beam B1 located in the main flow section can stop flowing. At the same time, since the first pulsed laser beam B1 is irradiated to the main flow section of the flow cell 30 by the laser generating unit 10, an induced plasma can be generated for nanoparticles in the liquid sample.

In the present invention, this process can be repeated. By measuring nanoparticles in the flowing liquid sample according to the above-described process, the reliability of nanoparticle measurement can be improved.

The flow device 20 can be configured so that the amount of liquid sample passing through the main flow section when the flow control section 50 is in the flow state is equal to or greater than the amount of liquid sample located in the main flow section when the flow control section 50 is in the flow-stop state. Through this configuration, the liquid sample exposed to the first pulsed laser beam B1 can be prevented from being exposed to the first pulsed laser beam B1 again, and measurement errors of nanoparticles can be prevented.

In an exemplary embodiment, the flow device 20 may include a separation unit that separates nanoparticles in the liquid sample before the liquid sample containing nanoparticles flows into the flow cell 30. For example, the separation unit may be placed between the flow cell 30 and the inlet portion 41 and configured to separate nanoparticles from the liquid sample flowing into the flow cell 30. The separation of nanoparticles may be performed based on the type of nanoparticle or the size of the nanoparticle.

The flow control unit 50 can be operated by receiving a control signal from the control unit 70.

The flow control unit 50 can control the flow cycle of the liquid sample. That is, the flow control unit 50 can control the cycle for the flow state and the flow-stop state of the liquid sample.

When the volume of the internal space of the flow portion through which the liquid sample flows is the same as the volume of the liquid sample, the flow control unit 50 can control the flow rate by adjusting the amount of the liquid sample flowing.

The flow control unit 50 may operate to stop the flow of the liquid sample in the flow cell 30 located upstream from the flow control unit 50. Alternatively, the flow control unit 50 may operate to cause the liquid sample in the flow cell 30 located upstream from the flow control unit 50 to flow.

Although the flow cell 30 is placed upstream from the flow control unit 50, it is not limited to the flow control unit 50. For example, if the flow cell 30 is located downstream from the flow control unit 50, the above operation can be performed in reverse. That is, movement of a piston in the pressurizing direction can cause the liquid sample in the flow cell 30 to operate in the flow state, and movement of the piston in the opposite direction to the pressurizing direction can cause the flow of the liquid sample in the flow cell 30 to stop.

Through this process, the flow control unit 50 can control the flow of the liquid sample so that the flow state of the liquid sample and the flow-stop state of the liquid sample operate at a certain cycle.

In order to measure the nanoparticles in the flow cell 30, a method of detecting and analyzing the shock wave and flash of the induced plasma can be used. However, it may be difficult to accurately analyze the composition of the nanoparticles by only detecting the image of the flash using a camera 112. In particular, when the size of the nanoparticles is small, the amount of nanoparticles is small, or the concentration of nanoparticles is low, accurate analysis of the nanoparticles may be even more difficult.

In addition, for spectrum analysis of light, acquisition of an optical signal of a certain amount or more is required, but laser-induced plasma is generated generally at a cycle interval of less than 1 second, making spectrum analysis difficult.

In addition, when a laser is generally irradiated on the flow cell 30, an optical signal S having a specific directionality for one side of the flow cell 30 can be formed. In this case, the intensity of the optical signal S for analysis may be weak, and spectrum analysis may be difficult.

Therefore, an embodiment of the present invention can propose a fluidic nanoparticle measurement device 1 that can accurately analyze the composition of nanoparticles by collecting spectral information of flash through a spectrometer 111.

In addition, an embodiment of the present invention can propose a photodetector 110 for fluidic nanoparticle measurement device. The photodetector can supplement the intensity of the optical signal S by using an integrating sphere 113 in which a fluid cell 30 is placed.

The fluidic nanoparticle measurement device 1 may include a signal detection unit 100.

Nanoparticles included in the liquid sample can be converted into a laser-induced plasma state by the first pulsed laser beam B1. The signal detection unit 100 can detect shock waves or flashes generated during this process. The signal detection unit 100 can detect various signals generated from the plasma. For example, the signal detection unit 100 can detect signals such as a spectrum of an element, a shock wave, an image of plasma, heat, and sound.

In an exemplary embodiment, the signal detection unit 100 may be positioned to have a certain distance from the source of the signal to be detected. In an exemplary embodiment, the signal detection unit 100 may be positioned on one side of the integrating sphere 113. For example, the signal detection unit 100 may penetrate the surface of the integrating sphere 113, so that at least a portion of the signal detection unit 100 may be positioned inside the integrating sphere 113.

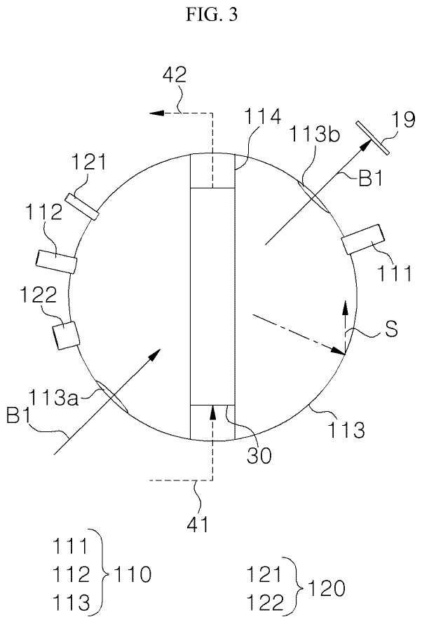

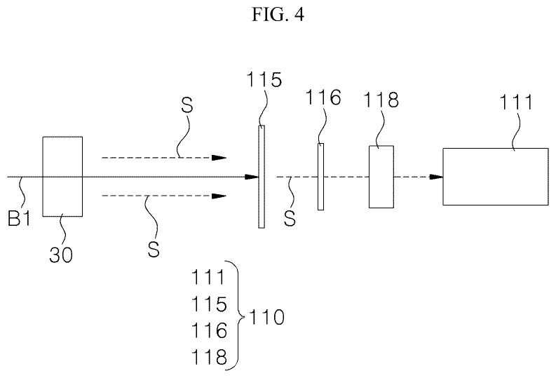

FIG. 3 is a drawing schematically illustrating components related to a photodetector according to an embodiment of the present invention, and FIG. 4 is a drawing schematically illustrating arrangement of components of the photodetector according to an embodiment of the present invention.

Referring to FIGS. 3 and 4, in an exemplary embodiment, the signal detection unit 100 may include a photodetector 110 and a shock wave detector 120 that detect different signals. The photodetector 110 according to an embodiment of the present invention can detect a flash generated when the laser-induced plasma is generated. For example, photodetector 110 can include a camera 112 and/or a spectrometer 111 for detecting the flash. In addition, the photodetector 110 can include an integrating sphere 113, a notch filter 115, an optical condenser 116, a cosine corrector 118, and an optical fiber for increasing the reliability of a signal to be detected through the camera 112 and/or the spectrometer 111. The integrating sphere 113, the optical condenser 116, and the cosine corrector 118 are for supplementing the intensity of the optical signal S and can be described as a light collecting unit.

In an exemplary embodiment, the photodetector 110 may include a spectrometer 111. The plasma induced by the first pulsed laser beam B1 may emit light of various wavelengths at a high temperature. This may be a phenomenon that occurs when a specific atom or ion is repeatedly excited and de-excited within the plasma. The light emitted by the induced plasma may include a unique spectrum of an element constituting the corresponding nanoparticle.

The spectrometer 111 can extract information on the chemical composition, concentration, or size of the nanoparticle by analyzing the spectrum of light emitted when the first pulsed laser beam B1 is irradiated on the nanoparticle.

In an exemplary embodiment, the photodetector 110 may include an integrating sphere 113. The integrating sphere 113 may have an inner surface formed into a perfect sphere. In addition, the inner surface of the integrating sphere 113 may be coated with a material having a high reflectivity so that light may be multiply reflected without being absorbed.

For example, at least a portion of the light propagating toward the inner surface of the integrating sphere 113 may be reflected at the inner surface of the integrating sphere 113. The light traveling inside the integrating sphere 113 may include at least one of visible light, infrared light, ultraviolet light, or microwaves.

For example, a space may be formed inside the integrating sphere 113. For example, the integrating sphere 113 may form a hollow portion. The inner surface of the integrating sphere 113 may face the hollow portion of the integrating sphere 113. For example, the inner surface of the integrating sphere 113 may define the hollow portion of the integrating sphere 113.

At least a portion of the inner surface of the integrating sphere 113 may form a curved surface. For example, at least a portion of the inner surface of the integrating sphere 113 may be a shape of the sphere. For example, a cross-section of at least a portion of the inner surface of the integrating sphere 113 may be a circular arc.

For example, at least a portion of the inner surface of the integrating sphere 113 may form an ellipsoid shape. For example, a cross-section of at least a portion of the inner surface of the integrating sphere 113 may form a shape of an ellipse.

For example, at least a portion of the inner surface of the integrating sphere 113 may form a paraboloid shape. For example, a cross-section of at least a portion of the inner surface of the integrating sphere 113 may form a parabola shape. The first opening 113a may be an opening formed in the integrating sphere 113.

The second opening 113b may be an opening formed in the integrating sphere 113. The first opening 113a and the second opening 113b may be positioned opposite each other. For example, the first opening 113a and the second opening 113b may be antipodes.

The opening 113a, 113b may include or mean at least one of the first opening 113a or the second opening 113b. A window may be coupled or connected to the opening 113a, 113b. The window located in the opening 113a, 113b may be formed of a light-transmitting material.

In an exemplary embodiment, the flow cell 30 may be positioned inside the integrating sphere 113. For example, the center of the integrating sphere 113 may be located in the flow cell 30. The flow cell 30 may be located between the first opening 113a and the second opening 113b. For example, a virtual line connecting the first opening 113a and the second opening 113b may pass through the flow cell 30. A flow cell holder 114 to which the flow cell 30 may be fixed may be disposed inside the integrating sphere 113. The flow cell 30 may be detachably coupled to the flow cell holder 114 inside the integrating sphere 113. The flow cell 30 may be detachably mounted to the flow cell holder 114 The flow cell 30 can be placed at the center of the integrating sphere 113 by the flow cell holder 114.

That is, the flow path through which the liquid sample including nanoparticles flows may be located inside the integrating sphere 113. For example, the inlet portion 41 and the outlet portion 42 of the flow cell 30 may be arranged to communicate with the first opening portion 113a and the second opening portion 113b of the integrating sphere 113, respectively.

For example, the flow cell 30 may extend from the inlet portion 41 to the outlet portion 42. The direction in which the flow cell 30 extends may be the longitudinal direction of the flow cell 30. The longitudinal direction of the flow cell 30 may be, for example, parallel to the direction from the inlet portion 41 to the outlet portion 42.

The first pulsed laser beam B1 can be irradiated to the flow cell 30. The first pulsed laser beam B1 can intersect the flow cell 30. The direction of propagation of the first pulsed laser beam B1 can be, for example, a direction from the first opening 113a toward the second opening 113b.

However, the arrangement structure of the inlet portion 41 and the outlet portion 42 of the flow cell 30 is not limited thereto. For example, the inlet portion 41 and the outlet portion 42 of the flow cell 30 may be arranged at different positions of the integrating sphere 113, respectively.

For example, the surface of the flow cell holder 114 can be coated with a material having high reflectivity so that light can be multiply reflected without being absorbed, similar to the inner surface of the integrating sphere 113.

The inner surface of the integrating sphere 113 and the surface of the flow cell holder 114 can be configured to reflect light of a preset wavelength. For example, the inner surface of the integrating sphere 113 and the surface of the flow cell holder 114 can reflect light of which wavelength is between 180 to 2500 nm.

Alternatively, the inner surface of the integrating sphere 113 and the surface of the flow cell holder 114 may be configured to reflect light in the wavelength range of 200 to 1100 nm. However, this reflection wavelength range is exemplary and is not limited thereto.

For example, the inner surface of the integrating sphere 113 and the surface of the flow cell holder 114 can be configured to reflect light of various wavelengths, such as ultraviolet rays, visible light, and infrared rays, depending on the light source.

In an exemplary embodiment, at least a portion of the first pulsed laser beam B1 incident into the interior of the integrating sphere 113 through the first opening 113a may be incident on the flow cell 30. At least a portion of the first pulsed laser beam B1 passing through the flow cell 30 may be discharged through the second opening 113b.

When the first pulsed laser beam B1 is irradiated onto the liquid sample of the flow cell 30, at least some of the nanoparticles in the liquid sample may receive energy from the first pulsed laser beam B1, thereby generating induced plasma. At this time, light emitted by the induced plasma may be multiply reflected on the inner surface of the integrating sphere 113 and evenly distributed within the interior of the integrating sphere 113.

Light generated from the induced plasma can form the optical signal S. For example, lights reflected on the inner surface of the integrating sphere 113 is evenly mixed, thereby generating an overall uniform optical signal S.

The spectrometer 111 of the photodetector 110 may be placed in the integrating sphere 113. For example, the spectrometer 111 may be spaced apart from the openings 113a, 113b and the flow cell 30. The spectrometer 111 may receive and detect light. For example, the spectrometer 111 may detect at least a portion of light incident on the spectrometer 111. The spectrometer 111 of the photodetector 110 may detect an optical signal S that is reflected and uniformed by the inner surface of the integrating sphere 113.

In the above, the flow cell 30 is described as being arranged inside the integrating sphere 113, but this is according to an exemplary embodiment of the present invention, and the arrangement structure of the flow cell 30 is not limited to this.

In an exemplary embodiment, the flow cell 30 may be positioned outside the integrating sphere 113. For example, the flow cell 30 may be positioned outside the integrating sphere 113 and adjacent to the integrating sphere 113.

In this case, when an induced plasma is generated by the first pulsed laser beam B1 irradiated on the flow cell 30, the optical signal S from the induced plasma may be incident on the inside of the integrating sphere 113 and multiply reflected from the inner surface of the integrating sphere 113.

The spectrometer 111 can detect a multiply reflected optical signal S by using the integrating sphere 113. At this time, the multiply reflected optical signal S can be transmitted to the spectrometer 111 through an optical fiber.

In an exemplary embodiment, the photodetector 110 may include a notch filter 115. The notch filter 115 may be positioned on the optical path through which the optical signal S is incident on the camera 112 and/or the spectrometer 111. For example, the notch filter 115 may be positioned on the optical path through which the optical signal S is incident on the spectrometer 111.

The notch filter 115 can block light of a preset specific wavelength and transmit light of the remaining wavelengths. For example, the notch filter 115 can block light of a wavelength of 532 nm. For example, the notch filter 115 can block light from the first pulsed laser beam B1 and transmit light emitted from the induced plasma.

When the camera 112 and/or spectrometer 111 analyze the emission flash from the induced plasma, if the intensity of the first pulsed laser beam B1 is stronger than the intensity of the plasma emission flash, noise may be generated by the first pulsed laser beam B1. Therefore, the notch filter 115 may be disposed on the optical path incident on the camera 112 and/or spectrometer 111. Accordingly, the first pulsed laser beam B1 is prevented from being incident on the camera 112 and/or spectrometer 111, thereby minimizing noise that may be generated during analysis.

In an exemplary embodiment, the photodetector 110 may include an optical condenser 116.

For example, the optical condenser 116 can be positioned adjacent to the location where the induced plasma is generated in order to collect the light emitted from the induced plasma. The optical condenser 116 can be placed so that the light emitted from the inducted plasma is aligned on an optical axis. For example, the light collected and amplified by the optical condenser 116 can be transmitted to the camera 112 and/or the spectrometer 111 through an optical fiber or the integrating sphere 113.

For example, when light emitted from the induced plasma is reflected inside the integrating sphere 113 and spreads in various directions, the optical condenser 116 can collect the optical signal S at a specific location and transmit it to the camera 112 and/or the spectrometer 111. The optical condenser 116 can focus multidirectional light reflected inside the integrating sphere 113 to minimize the loss of the light.

In addition, the optical condenser 116 can increase the intensity of light for analysis by reducing the spread of light emitted from the induced plasma and focusing the light. The optical condenser 116 can improve the signal-to-noise ratio by increasing the intensity of light for analysis.

For example, the optical condenser 116 may include a condenser lens. However, this is exemplary and not limited thereto, and it should be understood that anything capable of collecting an optical signal may be applied as long as it does not depart from the scope of the present invention.

In an exemplary embodiment, the photodetector 110 may include an optical fiber. The optical fiber may transmit the optical signal S from the induced plasma to the spectrometer 111. For example, the optical fiber may be configured to transmit the optical signal S that is multiply reflected from the inner surface of the integrating sphere 113 to the spectrometer 111.

For example, the optical fiber can provide a path for light collected by the optical condenser 116. For example, the optical fiber can be placed between the optical condenser 116 and the spectrometer 111 to transmit light collected by the optical condenser 116 to the spectrometer 111.

The optical fiber can minimize light loss through total internal reflection and provide a flexible light path toward the camera 112 and/or the spectrometer 111. The optical fiber can also minimize signal distortion and increase stability by protecting transmitted light from external electromagnetic interference.

In an exemplary embodiment, the photodetector 110 may further include a cosine corrector 118. For example, the cosine corrector 118 may be positioned between the optical condenser 116 and the spectrometer 111 to remove or correct the directionality of light incident on the spectrometer 111. In addition, the cosine corrector 118 may ensure a uniform optical signal at all angles.

The light emitted from the induced plasma may be reflected from the inner surface of the integrating sphere 113 and may spread in multiple directions. That is, even if the light is focused through the optical condenser 116, the light generated inside the integrating sphere 113 can still have multiple directions. The cosine corrector 118 can correct the residual asymmetry problem of the light mixed inside the integrating sphere 113. Accordingly, the cosine corrector 118 can ensure that the signal transmitted to the spectrometer 111 is reliable, and can enable the spectrometer 111 to collect spectrum data more precisely.

The fluidic nanoparticle measurement device 1 of the present invention can analyze in real time the properties of particles derived through absorption, scattering, or emission of light while the nanoparticles flow through the flow cell 30. In particular, in the present invention, the accuracy of estimating the type and size of nanoparticles flowing through the flow cell 30 can be improved by using the spectrometer 111 of the photodetector 110. In addition, according to an embodiment of the present invention, since the light generated from the induced plasma is reflected multiple times from the inner surface of the integrating sphere 113, even when the concentration of nanoparticles is low, the light can be amplified through multiple reflections to obtain a strong signal.

Meanwhile, the photodetector 110 may include a camera 112 capable of detecting the size of the nanoparticles. For example, the camera 112 may include a high-sensitivity CCD camera 112 or a CMOS camera 112. For example, the camera 112 may be disposed on one side of the integrating sphere 113 to detect light uniformed by the inner surface of the integrating sphere 113. For example, the camera 112 may be placed inside the integrating sphere 113 to detect the intensity distribution or pattern of scattered light, thereby estimating the average particle size of the nanoparticles.

Since the induced plasma is generated inside the integrating sphere 113, the light emitted from the asymmetrically distributed induced plasmas can be transformed homogeneous or uniform through the integrating sphere 113 so that it is easy to analyze the optical signal S. Accordingly, reliable data can be provided even when the concentration or distribution of the nanoparticles is not uniform.

Light emitted from the induced plasma may be strongly emitted in a specific direction or may be distributed asymmetrically. In an embodiment of the present invention, such asymmetry can be eliminated and the intensity of the signal may be uniformly distributed as the light is multiple-reflected inside the integrating sphere 113. In addition, since the light is dispersed into multiple paths during the multiple-reflection process and reaches a specific location again, the signal may be efficiently recycled. Accordingly, a weak signal can be transmitted to the spectrometer 111 and/or the camera 112 by being reflected multiple times without being lost in a single path.

In addition, according to an embodiment of the present invention, when the signal generated from the nanoparticles is weak, the integrating sphere 113 has the effect of amplifying the signal through multiple reflections, which enables the signal to be detected even if the liquid sample has a low concentration. That is, the integrating sphere 113 can spatially spread the weak signal and substantially increase the amount of light transmitted to the spectrometer 111 and/or camera 112.

In addition, since the integrating sphere 113 may automatically mix signals internally, the complexity due to optical path design or alignment can be reduced, and the average value of the entire signal can be stably measured without the need to selectively adjust signals in a specific direction.

The signal detection unit 100 may include a shock wave detector 120. The shock wave detector 120 can measure a laser-induced shock wave that accompanies the generation of laser-induced plasma. When the induced plasma is generated from nanoparticles by the first pulsed laser beam B1, the size and intensity of the generated plasma may differ depending on the size of the nanoparticles. A shock wave detector 120 can detect the shock wave generated when the induced plasma is generated.

In an exemplary embodiment, the shock wave detector 120 may include a piezoelectric element 122 and a microphone 121. A signal measured by the shock wave detector 120 may be amplified by an amplifier (e.g. lock-in amplifier).

The signal detection unit 100 according to an embodiment of the present invention can obtain information about nanoparticles by detecting shock waves or flashes. The information about nanoparticles can include the number or size of nanoparticles.

In an exemplary embodiment, the photodetector 110 and the shock wave detector 120 may be positioned at different locations on the surface of the integrating sphere 113. For example, the photodetector 110 and the shock wave detector 120 may be positioned with penetrating the surface of the integrating sphere 113, and thus at least a portion of the photodetector 110 and at least a portion of the shock wave detector 120 may be positioned inside the integrating sphere 113.

In an exemplary embodiment, the photodetector 110 and the shock wave detector 120 may be positioned adjacent to the flow cell 30. For example, the photodetector 110 and the shock wave detector 120 may be placed inside the flow cell 30, or may be arranged outside the flow cell 30. For example, the photodetector 110 and the shock wave detector 120 may be arranged to be in contact with the flow cell 30, or the photodetector 110 and the shock wave detector 120 may be arranged to be spaced apart from the flow cell 30.

In addition, the plurality of photodetectors 110 and the plurality of shock wave detectors 120 may be arranged around the flow cell 30. For example, the piezoelectric element 122 of the shock wave detector 120 may be provided in at least one or multiple numbers to detect a pressure change caused by a shock wave of the induced plasma. For example, at least some of the plurality of piezoelectric elements 122 may be attached to the surface of the flow cell 30. Alternatively, at least some of the plurality of piezoelectric elements 122 may be attached to the surface of the flow cell holder 114. Alternatively, at least some of the plurality of piezoelectric elements 122 may be attached to the surface of the integrating sphere 113.

In the present invention, the type of signal detection unit 100 is not limited, and various detectors corresponding to the detected signal can be applied.

The fluidic nanoparticle measurement device 1 may include a control unit 70.

The control unit 70 can control the overall operation of the fluidic nanoparticle measurement device 1. For example, the control unit 70 can control the laser generating device 12 or the flow control unit 50.

The control unit 70 can perform control regarding the generation of the pulsed laser beam B through the laser generating device 12. For example, the control unit 70 can control the laser generating device 12 to control the first cycle or generation time of the first pulsed laser beam B1. In addition, the control unit 70 can control the flow control unit 50 to control the second cycle or flow initiation time of the liquid sample. The control of the laser generating device 12 and the control of the flow control unit 50 by the control unit 70 can be performed independently. That is, the control unit 70 can control the laser generating device 12 and the flow control unit 50 respectively.

The control unit 70 can perform correction for the detection value based on the distance between the point where the induced plasma is generated inside the flow cell 30 and the signal detection unit 100 and the angle between the flow cell 30 and the signal detection unit 100.

Additionally, the control unit 70 can move the lens 18 with respect the flow cell 30 to adjust the focal length or focal point.

The control unit 70 can obtain information about nanoparticles from the signal detection unit 100. The control unit 70 can analyze the signal detected through the signal detection unit 100. The control unit 70 can determine information about the components and sizes of nanoparticles through the signals of the induced plasma detected through the photodetector 110 and the shock wave detector 120.

The control unit 70 can process the signal transmitted from the photodetector 110 to determine the type, size, concentration, etc. of the nanoparticles based on the light generated from the induction plasma. For example, the control unit 70 can detect the intensity and spectrum data of the signal incident on the camera 112 and/or the spectrometer 111 in real time. For example, the control unit 70 can classify the type of nanoparticles in real time based on the analyzed spectrum data, and can also automatically classify the spectrum data by comparing it with existing data through machine learning or a database-based algorithm.

For example, the control unit 70 can adjust the status of each optical component or provide an alarm based on the output data of the camera 112 or spectrometer 111.

In an exemplary embodiment, the control unit 70 can monitor the position and normal operation of the notch filter 115. The control unit 70 can adjust the position of the notch filter 115 or set a cutoff band to provide an alarm.

In an exemplary embodiment, the control unit 70 can finely adjust the focal length of the optical condenser 116. Accordingly, the control unit 70 can control the focus of the light from the plasma to reach the entrance of the optical fiber or the photodetector 110. For example, the control unit 70 can control the alignment so that the positions of the optical condenser 116 and the light from the plasma are located on the same optical axis. Alternatively, the control unit 70 can detect the alignment of the optical condenser 116 and provide an alarm. Alternatively, the control unit 70 can provide an alarm for switching to a preset lens according to the signal strength.

In an exemplary embodiment, the control unit 70 can periodically detect the signal transmission efficiency of the optical fiber and provide an alarm regarding damage and contamination status of the optical fiber.

In an exemplary embodiment, the control unit 70 can adjust the position of the cosine corrector 118 so that the signal from the light is uniformly transmitted to the entrance of the photodetector 110. For example, the control unit 70 can detect the uniformity of the signal to check the operating state of the cosine corrector 118.

The control unit 70 can determine the type, size, concentration, etc. of nanoparticles through the shock wave signal of the induced plasma through the shock wave detector 120.

The control unit 70 can comprehensively analyze signals detected through the photodetector 110 and the shock wave detector 120 to further improve the accuracy of determining information such as the type, size, and concentration of nanoparticles.

In an exemplary embodiment, the control unit 70 can preprocess a signal transmitted from the photodetector 110 and the shock wave detector 120. Through the preprocessing, the control unit 70 can amplify the signal detected from the shock wave detector 120, such as the piezoelectric element 122 or the microphone 121, by a signal amplifier (e.g. lock-in-amplifier).

The control unit 70 can remove noise in a low frequency range of 100 Hz or less through a bandpass filter. The filtered signal can be converted into a digital signal through a converter. The converted signal can extract signal values of a certain section according to conditions and perform a Fast Fourier Transform (FFT) in real time. Through this process, the control unit 70 can analyze the frequency component of a shock wave generated from the induced plasma by converting a function of time into a function of frequency. The control unit 70 can determine the type, size, or number of nanoparticles based on the frequency component or amplitude size converted from the detected shock wave.

As the size of the nanoparticle increases under the same energy conditions, the size of the plasma generated also increases, and the size of the shock wave may also increase accordingly. The control unit 70 can determine the type, size, or number of nanoparticles based on the frequency components and amplitude size of the shock wave.

The control unit 70 can measure the concentration of nanoparticles in the liquid sample based on the flow rate of the liquid sample flowing by the flow control unit 50 and information about nanoparticles detected from the signal detection unit 100.

Meanwhile, the fluidic nanoparticle measurement device 1 according to an exemplary embodiment of the present invention may further include a data storage capable of storing a signal detected through a signal detection unit 100 and/or information analyzed through a control unit 70.

The fluidic nanoparticle measurement device 1 of the present invention described above can more accurately determine the physical characteristics and chemical composition of nanoparticles to be measured by simultaneously analyzing shock waves and flashes emitted by induced plasma through the photodetector 110 and the shock wave detector 120.

In the above, even though all the components constituting the embodiments of the present invention have been described as being combined as one or operating in combination, the present invention is not necessarily limited to such embodiments. That is, within the scope of the purpose of the present invention, all the components may be selectively combined and operated in one or more. All terms, including technical or scientific terms, have the same meaning as generally understood by a person of ordinary skill in the art to which the present invention belongs, unless otherwise defined. Commonly used terms, such as terms defined in the dictionary, should be interpreted as being consistent with the contextual meaning of the related technology, and should not be interpreted in an ideal or excessively formal meaning, unless explicitly defined in the present invention.

The above description is merely an example of the technical idea of the present invention, and those skilled in the art will appreciate that various modifications and variations may be made without departing from the essential characteristics of the present invention. Accordingly, the embodiments disclosed in the present invention are not intended to limit the technical idea of the present invention, but to explain it, and the scope of the technical idea of the present invention is not limited by these embodiments. The protection scope of the present invention should be interpreted by the following claims, and all technical ideas within a scope equivalent thereto should be interpreted as being included in the scope of the rights of the present invention.

What is claimed is:

1. A photodetector comprising:
a flow cell configured to allow a liquid sample containing nanoparticles to flow;
a laser generating unit irradiating a pulsed laser beam on the flow cell and generating a plasma;
a flow control unit controlling a flow of the liquid sample inside the flow cell;
an integrating sphere reflecting multiply an optical signal from the plasma; and
a spectrometer measuring the optical signal reflected from the integrating sphere.

2. The photodetector of claim 1, wherein the spectrometer analyzes information on the nanoparticles through a spectrum of the optical signal.

3. The photodetector of claim 1, wherein an inner surface of the integrating sphere is coated so that the inner surface of the integrating sphere multiply reflects the optical signal.

4. The photodetector of claim 1, wherein the flow cell is disposed inside the integrating sphere.

5. The photodetector of claim 4, further comprising a flow cell holder placed in the integrating sphere, the flow cell holder fixing the flow cell.

6. The photodetector of claim 5, wherein the flow cell is detachably mounted to the flow cell holder.

7. The photodetector of claim 5, wherein a surface of the flow cell holder is configured to reflect the optical signal.

8. The photodetector of claim 7, wherein an inner surface of the integrating sphere and the surface of the flow cell holder are configured to reflect a light of wavelength between 180 to 2500 nm.

9. The photodetector of claim 8, wherein the inner surface of the integrating sphere and the surface of the flow cell holder are configured to reflect a light of wavelength between 200 to 1100 nm.

10. The photodetector of claim 1, wherein a flow path is formed inside the integrating sphere, wherein the liquid sample flows in the flow path.

11. The photodetector of claim 1, further comprising a notch filter disposed on a path along which the optical signal is incident on the spectrometer.

12. The photodetector of claim 1, further comprising an optical condenser collecting the optical signal reflected from an inner surface of the integrating sphere.

13. The photodetector of claim 1, further comprising an optical fiber connecting the integrating sphere and the spectrometer, wherein the optical fiber transmits the optical signal multiply reflected from the integrating sphere to the spectrometer.

14. The photodetector of claim 1, wherein a first opening is formed on a side of the integrating sphere,
wherein a second opening is formed on another side of the integrating sphere,
wherein the pulsed laser beam is configured to enter an interior of the integrating sphere through the first opening, and
wherein at least a portion of the pulsed laser beam is configured to exit the integrating sphere through the second opening.

15. The photodetector of claim 1, further comprising a camera detecting an image of the optical signal generated from the plasma, wherein the camera is displaced at a side of the integrating sphere.

16. The photodetector of claim 15, the spectrometer and the camera penetrate a surface of the integrating sphere, so that at least a portion of the spectrometer and at least a portion of the camera are positioned inside the integrating sphere.

17. The photodetector of claim 1, further comprising a data storage storing a signal detected through the spectrometer.

18. The photodetector of claim 1, wherein the laser generating unit includes an attenuator adjusting an intensity of the pulsed laser beam.
